(19) United States
(12) Patent Application Publication
(10) Pub. No.: US 2013/0013849 A1
(43) Pub. Date: Jan. 10, 2013

(54) Programmable Patch Architecture for ROM

(76) Inventors: Vishal V. Varma, San Jose, CA (US); Kamal J. Koshy, San Jose, CA (US)

(21) Appl. No.: 13/177,328

(22) Filed: Jul. 6, 2011

(51) Int. Cl. G06F 12/00; G06F 9/312

(52) U.S. Cl. 711/103; 712/205; 711/E12.008; 712/E09.033

(57) ABSTRACT

A system according to one embodiment includes a host central processing unit (CPU); a first storage medium configured to be in communication with the host CPU and to store information associated with at least one address; a second storage medium configured to be in communication with the host CPU, to store patch information associated with the at least one address of the first storage medium; and selection circuitry configured to, in response to a fetch instruction from the host CPU, select the patch information from the second storage medium if the fetch instruction contains a destination address that matches the at least one address associated with the patch information.

### FIELD

The present disclosure relates to code/data upgrading, and, more particularly, to a programmable patch architecture for read-only memory (ROM).

### BACKGROUND

Once an integrated circuit (IC) has gone through the tape-out process, updating code or data in the Read Only Memory (ROM) of the IC is difficult. Random Access Memory (RAM) does not have this limitation, but RAM requires more die area and consumes more power. In many applications, such as system-on-chip (SoC) and wireless chipsets, where die area and power are at a premium, system software will be implemented in ROM.

One method to update ROM system software or correct bugs discovered after tape-out, is to use a “fixtable,” in which each software function in ROM is a jump instruction back to System RAM. If a patch is needed, it can be executed from RAM and then control is returned ROM with another jump instruction. If a patch is not needed, control is immediately returned with a jump back to ROM. The disadvantage to this approach is that the fixtable needs to be implemented before tape-out and it is inefficient since control transfers are required, from ROM to RAM and back, for all functions, whether or not they are updated.

Another approach is to use central processing unit (CPU) instruction trapping, to transfer control out of ROM. This is also inefficient, however, and the number of instruction traps available is generally too limited and therefore not scalable.

Another approach is to implement registers through which software can configure ROM locations and patch data, but this approach has die size limitations and is also not scalable.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a system consistent with various embodiments of the present disclosure;

FIG. 2 illustrates a system consistent with various embodiments of the present disclosure;

FIG. 3 illustrates a flowchart of a method consistent with various embodiments of the present disclosure;

FIG. 4 illustrates a flowchart of a method consistent with various embodiments of the present disclosure;

Although the following Detailed Description will proceed with reference being made to illustrative embodiments, many alternatives, modifications, and variations thereof will be apparent to those skilled in the art.

### DETAILED DESCRIPTION

Generally, this disclosure provides systems (and methods) for a programmable patch architecture for ROM systems. In one system example, a content addressable memory (CAM) is provided as part of a chipset. As errors are discovered in the ROM, the address of those errors and corresponding patch code are stored in the CAM. When a processor issues an instruction address targeted to the ROM, the CAM compares that instruction address with its own list of known ROM addresses that point to faulty or outdated code or data. If a match is found, the patch code and/or patch data from the CAM is forwarded to the central processing unit (CPU), rather than the faulty code from the ROM. In another example, and for lengthy code updates/patches, RAM may be programmed with patch code/data, and the CAM may include jump instructions to jump to RAM to fetch the patch code/data. Advantageously, the use of a chipset CAM memory does not significantly impact chipset die area or power budget, but offers a scalable and programmable approach to ROM code patching. Also advantageously, in most cases an interrupt to the CPU may not be required to perform code patching via the CAM, and thus, overall system throughput is not impacted. In addition, the need for a software fixtable, which typically must be established after chipset tape out and before product shipment, is eliminated, since the CAM may be updated with patch code as ROM bugs/errors are identified.

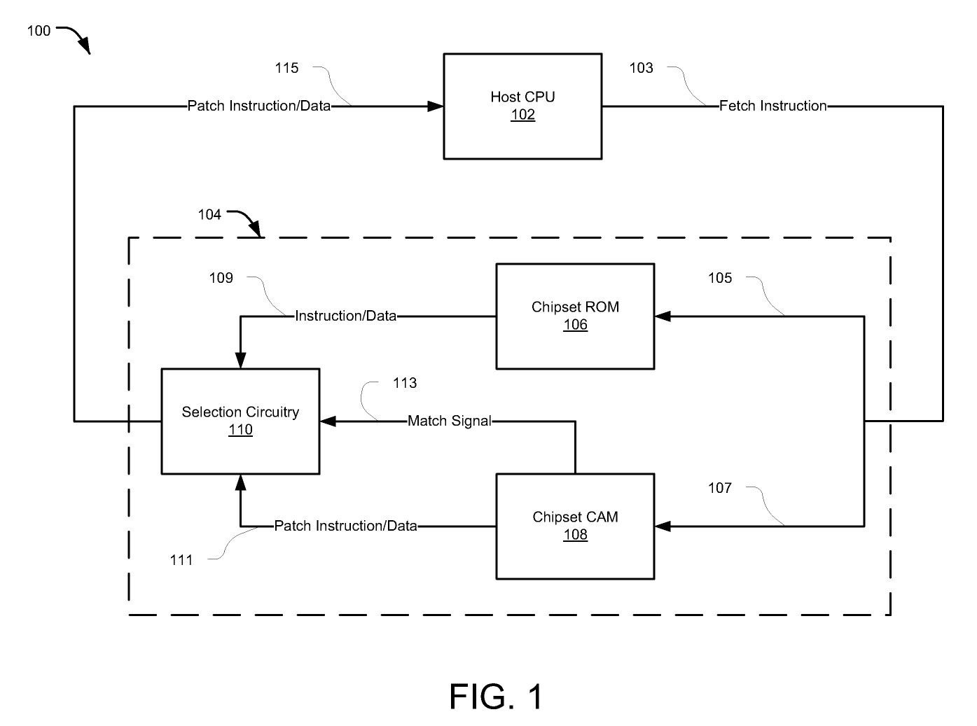

FIG. 1 illustrates a system 100 consistent with various embodiments of the present disclosure. The system 100 may include a host CPU 102 and a chipset 104. In general, the chipset 104 may include memory architecture that includes software implemented as ROM circuitry 106, CAM circuitry 108, and selection circuitry 110. In general, the host CPU 102 may include processor circuitry configured to, among other things, generate a command, such as fetch instruction 103, to fetch an instruction or data by an address located in the chipset ROM 106. The fetch instruction 103 typically includes an address where the instruction and/or data are located in one or more locations in ROM, for example an address of chipset ROM 106. Circuitry of the chipset ROM 106 may be organized in a typical manner, i.e., instructions or data are tied to a specific address. Circuitry of the chipset CAM 108 may be organized in a manner typical to existing hardware chipset CAM architecture, i.e. instructions or data are tied to a specific address and each bit of the memory may be wired to be compared to the input being received. Other embodiments or adaptations of the CAM architecture may be obvious to one skilled in the art in accordance with the embodiments described in the present disclosure. Selection circuitry 110 may be any circuitry that is configured to receive one or more inputs and select a subset of the one or more inputs. For example, the selection circuitry 110 may be implemented as comparator circuitry or multiplexer circuitry.

In one embodiment, the system 100 and chipset 104 of FIG. 1 may form part of, for example, an integrated circuit such as a wireless chipset and/or other chipset such as system-on chip (SoC), bus chipset, storage media controller chipset, etc. For example, the host CPU 102 may include a general-purpose CPU (which may include multiple CPU cores and/or multiple arithmetic logic units (ALUs), etc.) and/or a custom processor such as a digital signal processor (DSP). In another embodiment, the components described herein with reference to FIG. 1 may be discrete elements or integrated circuits. For example, integrated circuitry may include processor circuitry as described above, or other circuitry composed of discrete components. Discrete components may include resistors, transistors, etc. The term “circuit” or “circuitry,” as used in any embodiment herein, may comprise, for example, singly or in any combination, hardwired circuitry, programmable circuitry, state machine circuitry, and/or firmware that stores instructions executed by programmable circuitry.

Memory and/or memory associated with the chipset ROM 106 or chipset CAM 108 may comprise one or more of the following types of memory: semiconductor firmware memory, programmable memory, non-volatile memory, read only memory, electrically programmable memory, random access memory, flash memory, magnetic disk memory, and/or optical disk memory. Either additionally or alternatively, memory and/or memory associated with the chipset ROM 106 or chipset CAM 108 may comprise other and/or later-developed types of computer-readable memory.

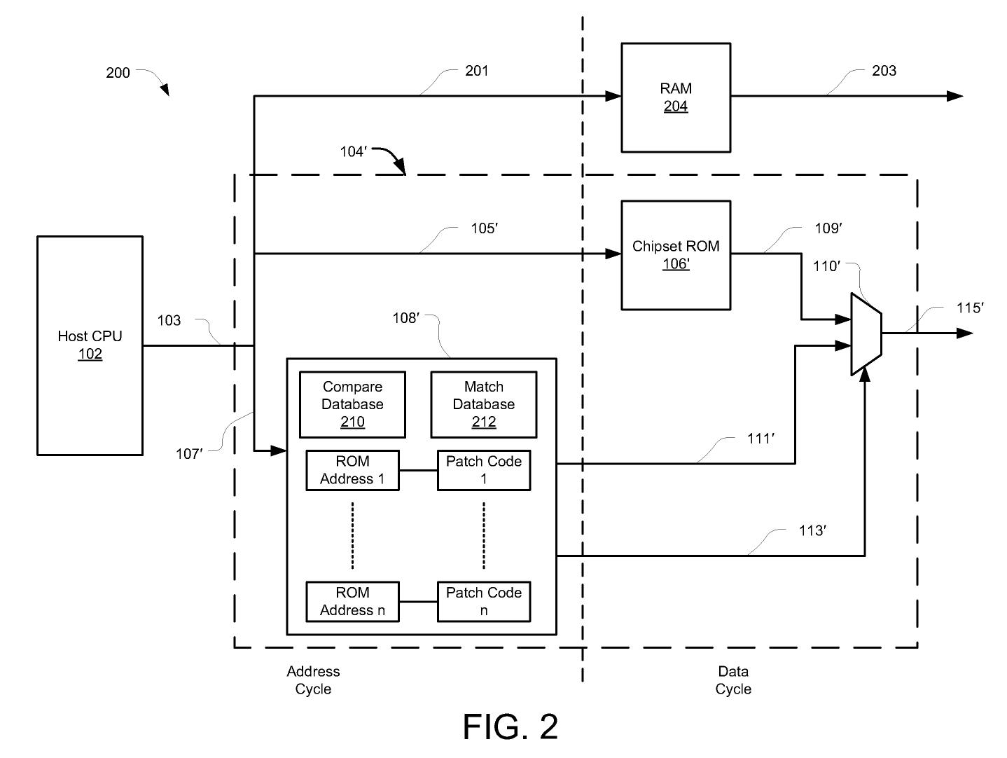

The host CPU 102 may be configured to request a location in memory by using a fetch instruction 103. The destination address of the fetch instruction 103 may be located in chipset ROM 106, for example. The fetch instruction 103 may also be sent to the chipset CAM 108. In one embodiment, the memory controller may receive the fetch instruction 103 and may make multiple requests to memory locations, i.e. one fetch instruction 105 may make a request to chipset ROM 106 and a second fetch instruction 107 may make a request to the chipset CAM 108. The chipset CAM 106 may contain addresses of the chipset ROM 106 that require patching and instructions or data to be retrieved in lieu of the instructions or data found in the associated destination address in the chipset ROM 106. The circuitry of the chipset CAM 108 may allow for simultaneous comparison amongst the addresses in the chipset CAM 108 memory locations as further discussed within the description of various embodiments of FIG. 2. If the destination address is loaded in the chipset CAM 106, the circuitry of the chipset CAM 106 may be configured to send a match signal 113 to the selection circuitry 108. If the instructions or data associated with the destination address of the fetch instruction 103 are loaded into the chipset CAM 106, the associated instructions or data are retrieved during the data cycle. The selection circuitry 108 may receive instructions or data 109 from the chipset ROM 106, patch instructions or data 111 from the chip set CAM 108, and/or a match signal 113. If the selection circuitry 108 receives patch instructions or data 111 from the chipset CAM 106, the patch instructions or data 115 are retrieved from the selection circuitry 110 to be executed by the host CPU 102. The selection circuitry 110 may be implemented as part of the memory controller circuitry or separate circuitry as may be required by implementation of the present disclosure.

FIG. 2 illustrates a system 200 consistent with various embodiments of the present disclosure. In general, the system 200 of FIG. 2 may include a host CPU 102 and a memory architecture that includes RAM circuitry 204, chipset ROM circuitry 106′, chipset CAM circuitry 108′, and selection circuitry 110′. Chipset ROM circuitry 106′ and chipset CAM circuitry 108′ may be organized in a typical manner as previously discussed in the description of FIG. 1. In one embodiment of FIG. 2, the circuitry of the chipset CAM 108′ may include a compare database 210 and a match database 212. The compare database 210 may contain addresses of the chipset ROM 106′ that require patching. The chipset CAM 108′ may allow for searching part of or the entirety of the memory space simultaneously within the chipset CAM 108′ as implementations may prefer. For example, the compare database 210 may be wired where each memory bit may be compared to an associated input bit of the destination address of fetch instruction 103. The size of the chipset CAM 108′ may be determined based on the size of chipset ROM 106′ and/or in accordance with balancing die area and power limitations. The match database 212 may contain instructions or data to be retrieved in lieu of the data found in the equivalent address in the chipset ROM 106′. The compare database 210 and/or match database 212 may be implemented as a table, array, or other data structure. In general, the compare database 210 is similar to a collection of unique key values in an associated array, and therefore could use any type of unique identification system retrievable by the host CPU 102. Other embodiments may allow for the compare database 210 to contain addresses of other memory types or identifiers associated with locations within a storage device. The match database 212 may contain any modified or replacement information including, but not limited to: data, a single instruction, multiple lines of instructions, a function, a jump instruction, or a software interrupt generation instruction associated with the entry point of an interrupt service routine. Selection circuitry 110 may be implemented as comparator circuitry, multiplexer circuitry, or other circuitry consistent with the present disclosure.

In one embodiment, the system of FIG. 2 may form part of, for example, an integrated circuit such as a SoC and/or other chipset such as a wireless chipset, bus chipset, storage media controller chipset, etc. For example, the host CPU 102 may include a general-purpose CPU (which may include multiple CPU cores and/or multiple ALUs, etc.) and/or a custom processor such as a DSP. In another embodiment, the components described herein with reference to FIG. 2 may be discrete elements or integrated circuits. For example, integrated circuitry may include processor circuitry as described above, or other circuitry composed of discrete components including resistors, transistors, etc. Memory and/or memory associated with the RAM 204, chipset ROM 106′, or chipset CAM 108′ may comprise one or more of the following types of memory: semiconductor firmware memory, programmable memory, non-volatile memory, read only memory, electrically programmable memory, random access memory, flash memory, magnetic disk memory, and/or optical disk memory. Either additionally or alternatively, memory and/or memory associated with the RAM 204, chipset ROM 106′, or chipset CAM 108′ may comprise other and/or later-developed types of computer-readable memory.

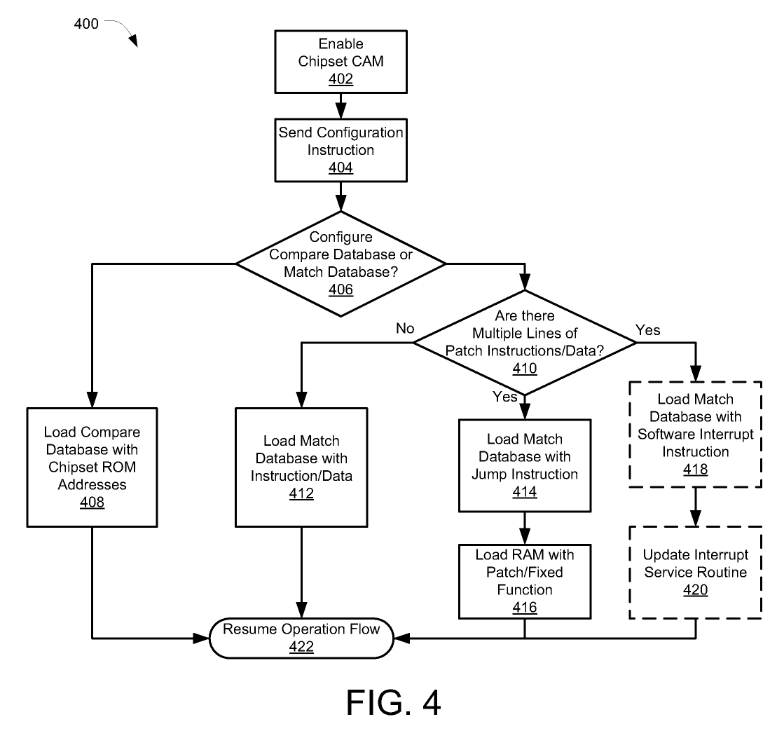

In one embodiment, the compare database 210 may be configured with an entry associated with an address of chipset ROM 106′ and a single 32 bit single line patch may be loaded into the associated entry in the match database 212; this is explained in more detail of the various embodiments of FIG. 4. During the operation flow, the host CPU 102 may issue a fetch instruction 103 to the memory location that may include a bad instruction or bad data. Intermediary circuitry, such as a memory controller or bridge, may provide access to the memory location. During the address cycle, the fetch instruction 103 may be received by the memory controller. If the fetch instruction 103 has a destination address located in RAM 204, the memory controller may send a fetch instruction 201 and the instruction or data 203 in the memory location in RAM 204 may be sent to the host CPU 102 for processing, which may include decoding and execution. If the fetch instruction 103 has a destination address located in chipset ROM 106′, the memory controller, in response, may issue the fetch instruction 105′ to the chipset ROM 106′. During the data cycle, the chipset ROM 106′ may send a bad 32 bit instruction or data 109′. The memory controller may additionally send a fetch instruction 107′ to the chipset CAM 108′ during the address cycle. The destination address of the fetch instruction 107′ may be compared to the entries in the compare database 210 and the chipset CAM 108′ may trap the address if the destination address matches an entry in the compare database 210. If the destination address of the fetch instruction 107′ is in the compare database 210, the good 32 bit instruction or data 111′ may be retrieved from the associated entry in the match database 212 for processing during the data cycle. Selection circuitry 110′ may receive the bad 32 bit instruction or data 109′ and the good 32 bit instruction or data 111′. The selection circuitry may also receive a match signal 113′. The selection circuitry 110′ may select the good 32 bit instruction or data 111′ over the bad 32 bit instruction or data 109′ depending on what is received by the selection circuitry 110′. The selection circuitry 110′ may then send the retrieved instructions or data 115′ to the host CPU 102 for decoding and execution. After the instructions of the retrieved instructions or data 115′ complete execution, the host CPU 102 may continue to fetch the next good address in chipset ROM 106′.

In another embodiment, the compare database 210 may be configured with an entry associated with the address of chipset ROM 106′ of the entry point of the function call and the match database 212 may be configured with an associated entry which may include a jump assembly instruction that includes an address indicating a location in RAM 204. During the operation flow, the host CPU 102 may fetch the address of chipset ROM 106′ of the bad function and the host CPU 102 may access the entry point of the function. The chipset CAM 108′ may trap the address of chipset ROM 106′ by looking up the address in the compare database 210. The chipset CAM 108′ may return the associated entry in the match database 212, which may manipulate the processing cycle, for example, by a jump instruction that includes adjusting the program counter of the host CPU 102. The host CPU 102 may be loaded with the jump instruction with a destination address located in RAM 204 and the processing cycle may be manipulated to continue execution from the location in RAM 204. The host CPU 102 may execute the instructions in RAM 204 starting with the first instruction located at the address of the instructions. These instructions may be encoded according to the instruction set architecture (ISA) of the host CPU 102. The order of execution of instructions may be influenced by the encoded instructions, processor architecture, or processing protocol, such as pipelining or concurrent processing over multiple cores. Once the last instruction of the function in RAM 204 is completed, control may be transferred back to the host CPU 102 at the end of the data cycle for beginning another cycle of instruction execution, such as at the next good address in chipset ROM 106′.

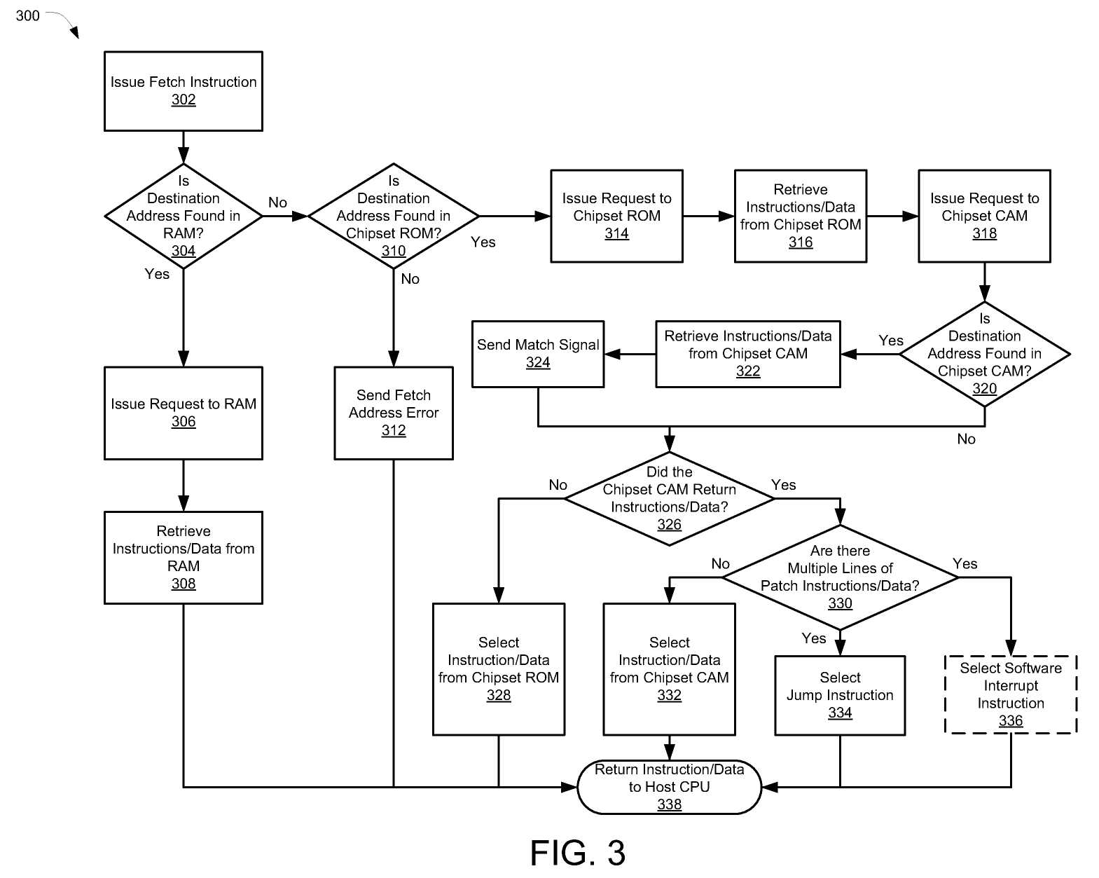

FIG. 3 illustrates a flowchart of a method 300 consistent with various embodiments of the present disclosure. With continued reference to FIGS. 1 and 2, and with reference numbers of FIGS. 1 and 2 omitted for clarity, the host CPU may issue a fetch instruction with a destination address to memory location 302. The system may utilize intermediary circuitry, such as a memory controller, to access the memory of the system and external memory, such as a wireless chipset. The memory controller may determine if the destination address of the fetch instruction is located in RAM 304. If the destination address is found in RAM, the memory controller may issue a request to retrieve the instructions or data from RAM 306. The instructions or data located at the destination address may be returned to the host CPU 308. The memory controller may determine that the destination address is located in chipset ROM 310. If the destination address is not in chipset ROM, then an error may be returned to the host CPU or the memory controller may make a request to another memory location 312. If the destination address is found in chipset ROM, then the memory controller may issue a request to the chipset ROM 314 and the instructions or data at the chipset ROM address may be retrieved 316. The memory controller may additionally issue a request to retrieve data from chipset CAM 318. The destination address may be compared to the address information in the chipset CAM 320. If a match is found, patch instructions or data may be retrieved from the chipset CAM 322. A match signal may also be sent to signify that a match was found in the chipset CAM 324. The selection circuitry may then select to send the instructions or data from the chipset CAM rather than the instructions or data from the chipset ROM 326. One embodiment may use the match signal, while another may verify that the selection circuitry received instructions or data from the chipset CAM. If a match signal or patch instructions or data were not received then the instructions or data from the chipset ROM may be selected to be sent to the host CPU 328. If patch instructions or data from the CAM or a match signal were received by the selection circuitry, the patch instructions or data received may be a single line of instructions or data or multiple lines of instructions or data 330. If the instructions or data are a single line of instructions or data then the chipset CAM instructions or data may be selected to be returned to the host CPU 332. If there are multiple lines of patch instructions or data or a function call, then a jump instruction with a destination address located in RAM may be returned to the host CPU 334. In another embodiment, the instruction being sent to the host CPU may be an instruction to signal a software interrupt which may allow the host CPU to execute an interrupt service routine 336. The instructions or data selected by the selection circuitry may be sent to the host CPU for further decoding and execution 338.

In various embodiments, the method of FIG. 3 may be modified according to the ISA of the host CPU. The implementation of the host CPU may also provide for pipelining and other forms of methods of processing and the method described herein may be adapted to be consistent with those methods and architectures. Organization of the chipset architecture may provide various adaptations of the present disclosure. For example, the memory controller may be modified to request and receive information from memory in accordance with the present disclosure or may contain the selection circuitry. Another embodiment may utilize memory buffers to execute the methods described within the present disclosure. Processing may take place according to the ISA or processing protocol of the host CPU in order to achieve proper execution and processing by the system components. System components may include an ALU or other logic devices. Control flow may also be modified in accordance with the present disclosure. For example, if the chipset CAM returns a jump instruction to RAM, control may be transferred back to the following address in chipset ROM once execution of the instructions in RAM are completed. Alternatively, the control may be transferred according to the instructions being executed or otherwise transferred according to the ISA or processing protocol of the CPU. In some embodiments the multiple line patch technique, described above, may be used to implement code or feature upgrades to the system software. For example, a new system software feature may be implemented as a function, containing multiple lines of code located in RAM 204. A jump instruction to that function may be placed in the chipset CAM match database 212 and be associated with a particular ROM address in the chipset CAM compare database 210. When the system software executes that particular ROM address, the selection circuitry 110′ may receive a match signal 113′ and select the jump instruction from the CAM match database 212 causing execution of the new feature function from RAM 204. At the completion of the new feature function another jump instruction may return execution to ROM. Alternatively, the new feature function may be implemented as an interrupt service routine in RAM 204 and the jump instruction may be replaced with a software interrupt generation instruction associated with that interrupt service routine.

FIG. 4 illustrates a flowchart of a method 400 consistent with various embodiments of the present disclosure. With continued reference to FIGS. 1 and 2, and with reference numbers of FIGS. 1 and 2 omitted for clarity, one step may be the initialization step when an error has been identified and a patch or fixed instructions are ready to be added to the chipset CAM. In one embodiment, operations may include enabling the chipset CAM 402. The chipset CAM may include a compare database and a match database. The host CPU of the system may send the patch or fixed instructions by using configuration instruction to the chipset CAM 404. In one embodiment, the data may be sent over the host-to-SoC interface 406, which may be communicating over, for example, universal serial bus (USB) or peripheral component interconnect express (PCIe). The configuration instruction may include the patch or fixed instructions and an address in chipset ROM. Configuration of the received data into the locations may be based on the destination of the information, the type of information being received, or some other indication mechanism 406. The memory address of the chipset ROM may be loaded into the compare database 408. The patch or fixed instructions may be loaded in the match database depending on whether the patch or fixed instructions is a single line of instructions or data or may include multiple lines of instructions or data 410. If the patch instructions or data is a single line of instructions or data, then the single line of instruction or data may be loaded into an entry in the match database of the chipset CAM that is associated with the memory address 412. If the patch instructions or data is a function or includes one or more lines of instructions, one embodiment may load a jump to RAM instruction into the entry in the match database associated with the memory location in the compare database 414. The function or one or more lines of instructions may be loaded into RAM at the RAM address of the jump to RAM instruction 416. In another embodiment, an instruction to signal a software interrupt may be loaded into the match database 418. The system may then update the interrupt service routine with patch instructions 420. Once the configurations to the chipset CAM and/or other system components, the chipset CAM may be ready to properly patch instructions or data in the chipset ROM and the operation flow may resume 422.

Embodiments of the methods described herein may be implemented in a computer program that may be stored on a storage medium having instructions to program a system to perform the methods. The storage medium may include, but is not limited to, any type of disk including floppy disks, optical disks, compact disk read-only memories (CD-ROMs), compact disk rewritables (CD-RWs), and magneto-optical disks, semiconductor devices such as ROMs, RAMs such as dynamic and static RAMs, erasable programmable read-only memories (EPROMs), electrically erasable programmable read-only memories (EEPROMs), flash memories, magnetic or optical cards, or any type of media suitable for storing electronic instructions. Other embodiments may be implemented as software modules executed by a programmable control device.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. An apparatus in communication with a host central processing unit (CPU), comprising:
a first storage medium configured to store information associated with at least one address;
a second storage medium configured to store patch information associated with the at least one address of the first storage medium; and
selection circuitry configured to, in response to a fetch instruction from the host CPU, select the patch information from the second storage medium if the fetch instruction contains a destination address that matches the at least one address associated with the patch information.

2. The apparatus of claim 1 wherein the second storage medium is configured, in response to the fetch instruction from the host CPU, retrieve the patch information during a first portion of a fetch cycle of an instruction cycle of the host CPU.

3. The apparatus of claim 2 wherein the selection circuitry is configured to, in response to the fetch instruction from the host CPU, retrieve the patch information during a second portion of the fetch cycle of the instruction cycle of the host CPU.

4. The apparatus of claim 1 wherein the selection circuitry is further configured to receive the information from the first storage medium and the patch information from the second storage medium.

5. The apparatus of claim 1 wherein the selection circuitry is further configured to send the patch information from the second storage medium to the host CPU in response to the fetch instruction from the host CPU if the destination address matches the at least one address associated with the patch information.

6. The apparatus of claim 1 wherein the first storage medium is implemented as read-only memory (ROM) and the second storage medium is implemented as content addressable memory (CAM) wherein the CAM is configured to search each address of at least a portion of addresses of the CAM simultaneously in response to the fetch instruction from the host CPU.

7. The apparatus of claim 1 wherein the information is selected from the group consisting of a first at least one datum, a first at least one instruction, a first jump instruction, and a first interrupt instruction and the patch information is selected from the group consisting of a second at least one datum, a second at least one instruction, a second jump instruction, and a second interrupt instruction.

8. The apparatus of claim 7 wherein the second jump instruction, when executed by the host CPU, configures the host CPU to retrieve a third at least one instruction from a third storage medium, the third storage medium configured to contain a plurality of instructions.

9. The apparatus of claim 7 wherein the second interrupt instruction, when executed by the host CPU, configures the host CPU to execute an interrupt service routine.

10. A system, comprising:
a host central processing unit (CPU);
a first storage medium configured to be in communication with the host CPU and to store information associated with at least one address;
a second storage medium configured to be in communication with the host CPU, to store patch information associated with the at least one address of the first storage medium; and
selection circuitry configured to, in response to a fetch instruction from the host CPU, select the patch information from the second storage medium if the fetch instruction contains a destination address that matches the at least one address associated with the patch information.

11. The system of claim 10 wherein the second storage medium is configured, in response to the fetch instruction from the host CPU, retrieve the patch information during a first portion of a fetch cycle of an instruction cycle of the host CPU.

12. The system of claim 11 wherein the selection circuitry is configured to, in response to the fetch instruction from the host CPU, retrieve the patch information during a second portion of the fetch cycle of the instruction cycle of the host CPU.

13. The system of claim 10 wherein the selection circuitry is further configured to receive the information from the first storage medium and the patch information from the second storage medium.

14. The system of claim 10 wherein the selection circuitry is further configured to send the patch information from the second storage medium to the host CPU in response to the fetch instruction from the host CPU if the destination address matches the at least one address associated with the patch information.

15. The system of claim 10 wherein the first storage medium is implemented as read-only memory (ROM) and the second storage medium is implemented as content addressable memory (CAM) wherein the CAM is configured to search each address of at least a portion of addresses of the CAM simultaneously in response to the fetch instruction from the host CPU.

16. The system of claim 10 wherein the information is selected from the group consisting of a first at least one datum, a first at least one instruction, a first jump instruction, and a first interrupt instruction and the patch information is selected from the group consisting of a second at least one datum, a second at least one instruction, a second jump instruction, and a second interrupt instruction.

17. The system of claim 16 wherein the second jump instruction, when executed by the host CPU, configures the host CPU to retrieve a third at least one instruction from a third storage medium, the third storage medium configured to contain a plurality of instructions.

18. The system of claim 16 wherein the second interrupt instruction, when executed by the host CPU, configures the host CPU to execute an interrupt service routine.

19. A method for data/instruction retrieval in communication with a host central processing unit (CPU), comprising:
receiving a fetch instruction from the host CPU, the fetch instruction having a destination address;
retrieving information associated with at least one address of a first storage medium in response to the fetch instruction from the host CPU;
retrieving patch information from a second storage medium in response to the fetch instruction from the host CPU, the patch information associated with the at least one address in the first storage medium; and
selecting the patch information to the host CPU if the destination address matches the at least one address associated with the patch information.

20. The method of claim 19 wherein retrieving patch information from a second storage medium in response to the fetch instruction from the host CPU happens during a first portion of a fetch cycle of an instruction cycle of the host CPU.

21. The method of claim 19 further comprising retrieving the patch information during a second portion of the fetch cycle of the instruction cycle of the host CPU in response to the fetch instruction from the host CPU.

22. The method of claim 19 further comprising sending the patch information from the second storage medium to the host CPU in response to the fetch instruction from the host CPU if the destination address matches the at least one address associated with the patch information.

23. The method of claim 19 further comprising searching each of the at least one address of the second storage medium simultaneously in response to the fetch instruction from the host CPU.

24. The method of claim 19 wherein the information is selected from the group consisting of a first at least one datum, a first at least one instruction, a first jump instruction, and a first interrupt instruction and the patch information is selected from the group consisting of a second at least one datum, a second at least one instruction, a second jump instruction, and a second interrupt instruction

25. The method of claim 24 further comprising retrieving a third at least one instruction from a third storage medium, the third storage medium configured to store a plurality of instructions.

26. The method of claim 24 further comprising executing an interrupt service routine.

27. A tangible computer-readable medium including instructions stored thereon which, when executed by one or more processors, cause the computer system to perform operations comprising:
receiving a fetch instruction from a host central processing unit (CPU), the fetch instruction having a destination address;
retrieving information associated with at least one address of a first storage medium in response to the fetch instruction from the host CPU;
retrieving patch information from a second storage medium in response to the fetch instruction from the host CPU, the patch information associated with the at least one address in the first storage medium; and
selecting the patch information to the host CPU if the destination address matches the at least one address associated with the patch information.

28. The tangible computer-readable medium of claim 27, wherein the instruction that when executed by one or more of the processors results in retrieving patch information from a second storage medium in response to the fetch instruction from the host CPU happens during a first portion of a fetch cycle of an instruction cycle.

29. The tangible computer-readable medium of claim 27, wherein the instructions that when executed by one or more of the processors result in the following additional operation retrieving the patch information during a second portion of the fetch cycle of the instruction cycle in response to the fetch instruction from the host CPU.

30. The tangible computer-readable medium of claim 27, wherein the instructions that when executed by one or more of the processors result in the following additional operation comprising sending the patch information from the second storage medium to the host CPU in response to the fetch instruction from the host CPU if the destination address matches the at least one address associated with the patch information.

31. The tangible computer-readable medium of claim 27, wherein the instructions that when executed by one or more of the processors result in the following additional operation comprising searching each of the at least one address of the second storage medium simultaneously in response to the fetch instruction from the host CPU.

32. The tangible computer-readable medium of claim 27 wherein the information is selected from the group consisting of a first at least one datum, a first at least one instruction, a first jump instruction, and a first interrupt instruction and the patch information is selected from the group consisting of a second at least one datum, a second at least one instruction, a second jump instruction, and a second interrupt instruction

33. The tangible computer-readable medium of claim 32, wherein the instructions that when executed by one or more of the processors result in the following additional operation comprising retrieving at least one instruction from a third storage medium, the third storage medium configured to store a plurality of instructions.

34. The tangible computer-readable medium of claim 32, wherein the instructions that when executed by one or more of the processors result in the following additional operation comprising executing an interrupt service routine.
